(19) United States
(12) Patent Application Publication
(10) Pub. No.: US 2011/0021207 A1
(43) Pub. Date: Jan. 27, 2011

(54) System and Method for Estimating Positioning Error Within a WLAN-Based Positioning System

(76) Inventors: Edward J. MORGAN, Needham, MA (US); Farshid ALIZADEH-SHABDIZ, Wayland, MA (US); Oleksiy IGNATYEV, Brighton, MA (US)

Correspondence Address: WILMERHALE/BOSTON, 60 STATE STREET, BOSTON, MA, 02109, US

(21) Appl. No.: 12/508,828

(22) Filed: Jul. 24, 2009

(51) Int. Cl. H04W 24/00

(52) U.S. Cl. 455/456.1

(57) ABSTRACT

The invention features a method of estimating an expected error of a position estimate for use in a WLAN positioning system that estimates the position of a WLAN-enabled device. The WLAN-enabled device receives signals transmitted by at least one WLAN access point in range of the WLAN-enabled device, and a position of the WLAN-enabled device is estimated based on the received signals from the at least one WLAN access point in range. A signal strength value is measured for the signals transmitted by the at least one WLAN access point, and a maximum signal strength value is determined. The method also estimates an expected error of the position estimate based on the maximum signal strength value of the signals transmitted by the at least one WLAN access point in range of the WLAN enabled device. The expected error predicts a relative accuracy of the position estimate.

### CROSS-REFERENCE TO RELATED APPLICATIONS

This application is related to the following U.S. patent applications, the contents of which are hereby incorporated by reference:
U.S. patent application Ser. No. 11/261,987, entitled Method and System for Building a Location Beacon Database, filed on Oct. 28, 2005;
U.S. patent application Ser. No. 11/430,079, Estimation Of Speed and Direction of Travel in A WLAN Positioning System, filed on May 8, 2006;
U.S. patent application Ser. No. 11/430,064, Estimation of Speed and Direction of Travel in A WLAN Positioning System Using Multiple Position Estimations, filed on May 8, 2006;
U.S. patent application Ser. No. 11/430,222, Estimation of Position Using WLAN Access Point Radio Propagation Characteristics In a WLAN Positioning System, filed on May 8, 2006;
U.S. patent application Ser. No. 11/430,224, Calculation of Quality of WLAN Access Point Characterization for Use In a WLAN Positioning System, filed on May 8, 2006; and
U.S. patent application Ser. No. 11/625,450, filed on Jan. 22, 2007, entitled System and Method For Estimating Positioning Error Within A WLAN-Based Positioning System.

### BACKGROUND

1. Field of the Invention

The invention generally relates to estimating error in a WLAN-based positioning system and, more specifically, to determining the expected error of an estimated position of a WLAN-enabled mobile device using WLAN-based positioning system.

2. Discussion of Related Art

Estimation is the process of finding the most probable value for a target parameter(s) based on a set of observable samples, which are correlated with the target parameter(s). Accuracy of the estimation can vary based on the quality of the observed samples. Quantifying the quality of estimation is one of the main subjects in estimation theory, and in most of the cases, it is an even harder problem than estimating the target parameter. A satellite based positioning system is one of the early systems that was introduced for global positioning, and for the same reason it is called Global Positioning System (GPS). In the GPS network, accuracy of estimation is also determined and reported to end users. The estimation error in the GPS network is presented in different ways. The error estimation is determined by considering the entire network, and it is called Delusion Of Precision (DOP) for horizontal and vertical error. The DOP value is an indicator of error, and it can be translated to error in meters as well.

Metro wide WLAN-based positioning systems have been explored by a couple of research labs, but none of them provided an expected error of position estimation. The most important research efforts in this area have been conducted by PlaceLab (www.placelab.com, a project sponsored by Microsoft and Intel), University of California San Diego ActiveCampus project (ActiveCampus—Sustaining Educational Communities through Mobile Technology, technical report #CS2002-0714), and the MIT campus wide location system.

There have been a number of commercial offerings of WLAN location systems targeted at indoor positioning. (See, e.g., Kavitha Muthukrishnan, Maria Lijding, Paul Having a, Towards Smart Surroundings: Enabling Techniques and Technologies for Localization, Proceedings of the International Workshop on Location and Context-Awareness (LoCA 2005) at Pervasive 2005, May 2005, and Hazas, M., Scott, J., Krumm, J.: Location-Aware Computing Comes of Age, IEEE Computer, 37(2):95-97, February 2004 005, Pa005, Pages 350-362.) These systems are designed to address asset and people tracking within a controlled environment like a corporate campus, a hospital facility or a shipping yard. The classic example is having a system that can monitor the exact location of the crash cart within the hospital so that when there is a cardiac arrest the hospital staff doesn't waste time locating the device. The accuracy requirements for these use cases are very demanding, typically calling for 1-3 meter accuracy. These systems use a variety of techniques to fine tune their accuracy including conducting detailed site surveys of every square foot of the campus to measure radio signal propagation. They also require a constant network connection so that the access point and the client radio can exchange synchronization information similar to how A-GPS works. While these systems are becoming more reliable for indoor use cases, they are ineffective in any wide-area deployment. It is impossible to conduct the kind of detailed site survey required across an entire city and there is no way to rely on a constant communication channel with 802.11 access points across an entire metropolitan area to the extent required by these systems. Most importantly, outdoor radio propagation is fundamentally different than indoor radio propagation, rendering these indoor positioning techniques almost useless in a wide-area scenario.

There are millions of commercial and private WLANs deployed so far and this number is growing everyday. Thus, WLAN access points are used to estimate the location of WLAN-enabled mobile devices.

### SUMMARY

In one aspect, the invention features a method of estimating an expected error of a position estimate for use in a WLAN positioning system that estimates the position of a WLAN-enabled device. The WLAN-enabled device receives signals transmitted by at least one WLAN access point in range of the WLAN-enabled device, and the method estimates the position of the WLAN-enabled device based on the received signals from the at least one WLAN access point in range of the WLAN enabled device. A signal strength value is measured for the signals transmitted by the at least one WLAN access point, and a maximum signal strength value is determined for the measured signal strength values. The method also estimates an expected error of the position estimate based on the maximum signal strength value of the signals transmitted by the at least one WLAN access point in range of the WLAN enabled device. The expected error predicts a relative accuracy of the position estimate.

In one aspect of the invention, a system for estimating an expected error of a position estimate in a WLAN positioning system that estimates the position of a WLAN-enabled device includes a WLAN-enabled device for receiving signals transmitted by at least one WLAN access point in range of the WLAN-enabled device. The system also includes a computer readable medium comprising instructions that, when executed, cause a computer system to estimate the position of the WLAN-enabled device based on the received signals from the at least one WLAN access point in range of the WLAN enabled device. The instructions also cause the computer system to measure a signal strength value for the signals transmitted by the at least one WLAN access point and determine a maximum signal strength value for the measured signal strength values. The instructions also cause the computer system to estimate an expected error of the position estimate based on the maximum signal strength value of the signals transmitted by the at least one WLAN access point in range of the WLAN enabled device, wherein the expected error predicts a relative accuracy of the position estimate.

In another aspect of the invention, the position estimate of the WLAN-enabled device is based on signals from a plurality of WLAN access point in range of the WLAN-enabled device. The expected error of the position estimate of the WLAN-enabled device is based on a weighted average of a first, second, third, and fourth expected error value. The first expected error value is estimated based on the maximum signal strength value of the signals transmitted by the plurality of WLAN access points in range of the WLAN enabled device. The second expected error value is estimated based on the number of WLAN access points of the plurality used to estimate the position of the WLAN enabled device. The third expected error value is estimated based on a smallest signal coverage area of the plurality of WLAN access points used to estimate the position of the WLAN-enabled device. The fourth expected error value is estimated based on a spatial spread of the geographic positions of the plurality of WLAN access points used to estimate the position of the WLAN-enabled device. The spatial spread is based on a distance between the geographic positions of the plurality of WLAN access points used to estimate the position of the WLAN-enabled device.

In yet a further aspect of the invention, the first, second, third, and fourth expected error values are weighted according to corresponding correlation coefficients, each correlation coefficient measuring the accuracy with which its corresponding expected error value predicts the actual error.

In still another aspect of the invention, based on the number of WLAN access points in range of the WLAN-enabled device for which signals are received, a corresponding weighted average algorithm for estimating the expected error of the position estimate is chosen from a plurality of weighted average algorithms. The chosen weighted average algorithm is suited for the number of WLAN access points in range of the WLAN-enabled device for which signals are received.

### BRIEF DESCRIPTION OF DRAWINGS

In the drawings,

FIG. 1 illustrates certain embodiments of a WLAN positioning system;

FIG. 2 illustrates an example of a WLAN-enabled mobile device and surrounding access points and their corresponding coverage areas.

FIG. 3 illustrates an example of the impact of the spatial spread of detected WLAN access points on the accuracy of position estimation of a WLAN-enabled mobile device.

FIG. 4 illustrates an example of the impact of the number of detected WLAN access points on the accuracy of a position estimate of a WLAN-enabled mobile device.

FIG. 5 illustrates an example of the impact of the maximum signal strength of detected WLAN access points on the accuracy of a position estimate of a WLAN-enabled mobile device.

FIG. 6 illustrates a flow chart of a process for determining an expected error of a position estimate of a mobile device.

FIG. 7 illustrates a flow chart of a process for determining an expected error of a position estimate of a mobile device in two different usage cases.

### DETAILED DESCRIPTION

Preferred embodiments of the invention estimate the error associated with a derived position provided by a WLAN positioning system. The incorporated patent applications describe a WLAN-based positioning system that can derive and provide estimated positions for WLAN-enabled devices.

Preferred embodiments of the invention determine and update the expected error of position estimates of a WLAN-based positioning system that use public and private WLAN access points. (Note that 802.11, 802.11b, 802.11e, 802.11n, and WiFi are examples of WLAN standards.) The user's mobile device periodically scans and detects public and private WLAN access points and also logs signals characteristics of each of the WLAN access points, for example, Received Signal Strength (KSS), Time Difference of Arrival (TDOA), or Time difference of Arrival (TOA) corresponding to each of the WLAN access points. In some embodiments, the mobile device itself determines the expected error of a position estimate. In other embodiments, the mobile device sends the results of scanning the surrounding WLAN access points to a central site where a central server determines the expected error.

The expected error of a WLAN position estimate may be used to quantify the quality of the position estimate. This may be useful when multiple position estimates are combined or when the WLAN-based position estimates are combined with other position estimation techniques, e.g., GPS position estimation. The expected error of each position estimate may be used as a weighting factor when a series of position estimates are combined. For example, in order to increase the accuracy of single position estimate, multiple position estimates may be a weighted average. In this case, the expect error of each position estimate is used as a weight in a weighted average calculation.

In addition, a series of position estimates may be combined to derive the mobile device's speed of travel or bearing. When such a series of position estimates are combined, the expected error of each estimate is used as a corresponding quality metric of the estimation, which enables the optimal combination of the series of position estimates based on their quality.

For example, in a series of ten position estimates, assume all but the seventh position estimate have a relatively low expected error of position estimation, while the seventh position estimate has a relatively high expected error. When the mobile device uses this series of position estimates to derive the speed of the mobile device, the mobile device may exclude the seventh position estimate in the speed determination because its relatively high expected error value indicates that that particular position estimate is of low quality and, thus, may be unreliable.

The expected error of a position estimates may also be used to determine the expected error after combining the position estimate results. For example, if the position estimate results are used to determine speed of travel, the expected errors of individual position estimates are combined to determine the estimation error of the speed of travel.

Certain embodiments of the invention build on techniques, systems and methods disclosed in earlier filed applications, including but not limited to U.S. patent application Ser. No. 11/261,848, entitled Location Beacon Database, U.S. patent application Ser. No. 11/261,898, entitled Server for Updating Location Beacon Database, U.S. patent application Ser. No. 11/261,987, entitled Method and System for Building a Location Beacon Database, and U.S. patent application Ser. No. 11/261,988, entitled Location-Based Services that Choose Location Algorithms Based on Number of Detected Access Points Within Range of User Device, all filed on Oct. 28, 2005, and also including but not limited to U.S. patent application Ser. No. 11/430,224, entitled Calculation of Quality of WLAN Access Point Characterization for Use in a WLAN Positioning System, and U.S. patent application Ser. No. 11/430,222, entitled Estimation of Position Using WLAN Access Point Radio Propagation Characteristics in a WLAN Positioning System, both filed on May 8, 2006, the contents of which are hereby incorporated by reference in their entirety. Those applications taught specific ways to gather high quality location data for WLAN access points so that such data may be used in location based services to determine the geographic position of a WLAN-enabled device utilizing such services and techniques of using said location data to estimate the position of a system user. The present techniques, however, are not limited to systems and methods disclosed in the incorporated patent applications. Thus, while reference to such systems and applications may be helpful, it is not believed necessary to understand the present embodiments or inventions.

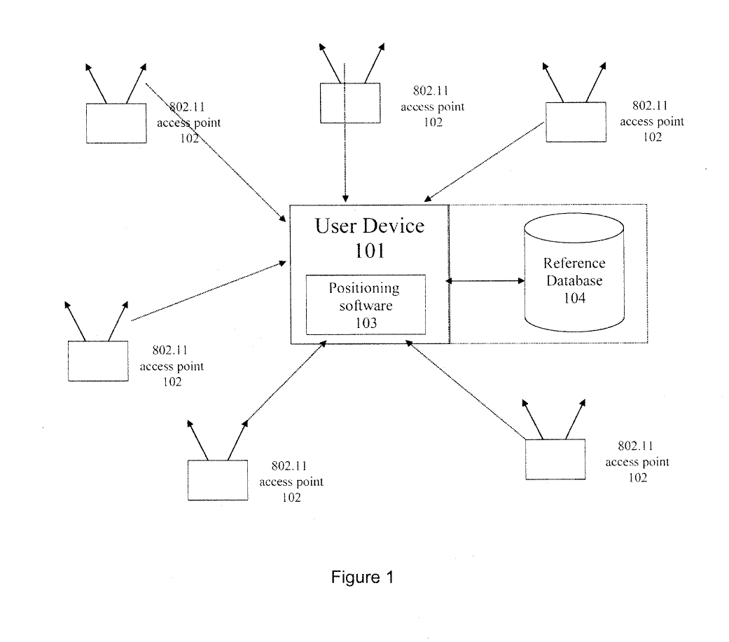

FIG. 1 depicts a WLAN positioning system (WPS). The positioning system includes positioning software [103] that resides on a user device [101]. Throughout a particular target geographical area, there are fixed wireless access points [102] that broadcast information using control/common channel broadcast signals. The client device monitors the broadcast signal or requests its transmission via a probe request. Each access point contains a unique hardware identifier known as a MAC address. The client positioning software 103 receives signal beacons from the 802.11 access points 102 in range and determines the geographic location of the user device 101 using characteristics from the signal beacons. Those characteristics include the access point's MAC address and the strengths of the signal reaching the client device. The client software compares the observed 802.11 access points with those in its reference database [104] of access points, which may or may not reside on the device as well (i.e., in some embodiments, the reference database can be remotely located). The reference database contains the estimated geographic locations and power profile of all the access points the gathering system has collected. The power profile may be generated from a collection of readings that represent the power of the signal from various locations. Using these known locations and power profiles, the client software determines the relative position of the user device [101] and determines its geographic coordinates in the form of latitude and longitude readings. Those readings are then provided to location-based applications such as friend finders, local search web sites, fleet management systems and E911 services.

Preferred embodiments of the invention may be used in a WLAN-enabled device to determine and update expected error of position estimates. For example, techniques in accordance with embodiments of the invention may be incorporated in logic embedded in positioning software [103] of the WLAN-enabled device of FIG. 1.

Under one embodiment of the invention, the expected error of a position estimate of a WLAN-enabled mobile device is estimated based on the coverage area of all of the access points used to locate the WLAN-enabled mobile device. In other words, if all the detected access points are considered, the signal foot prints (or the coverage areas) of the detected access points are used to determine the expected error of the position estimate. In one illustrative implementation, the expected error of the position estimate is bounded by the smallest coverage area of the access points that are used to estimate the location of a WLAN-enabled mobile device. Therefore, the method is based on finding the smallest coverage area among the access points that are used to estimate the location of an end user in a WLAN-based positioning system. The expected error is directly correlated with the smallest coverage of detected WLAN access points. If the expected error is denoted by e, and the smallest coverage is denoted by Cₘᵢₙ the error can be written as a function of the smallest coverage as follows:

e∝f(Cₘᵢₙ)

The notation ∝ means direct dependency. One example of the function is as follows:

e=K_{c}Cₘᵢₙ

The parameter K_{c} is a constant number to scale the value of smallest coverage area to the actual error in meters. The parameter K_{c} translates the minimum coverage in m² to error in meters. The parameter K_{c} is found empirically by considering enough samples in the entire coverage area and finding the actual error and the Cₘᵢₙ value. The actual error can be deter mined by comparing the estimated position provided by the WLAN positioning system with a known position.

The coverage area or the footprint of a WLAN access point is defined as the area in which a WLAN-enabled mobile device can detect the particular access point. The coverage area of an access point is found by systematically scanning a target geographical area containing many access points and recording Received Signal Strength (RSS) samples at known locations. When all the samples of a given access point are considered, the standard deviation of the location of the RSS samples is used as an indicator of the size of the coverage area of the access point. In some embodiments, all RSS samples are considered. In other implementations, some RSS samples are ignored if the RSS is below a given threshold. If the total number of RSS samples of an access point is denoted by M and the corresponding location of RSS sample i is denoted by (xᵢ, yᵢ), the standard deviation, σ, of coverage area is calculated as follows:

σ=\sqrt{σₓ²+σ_{y}²},

in which σₓ and σ_{y} are the standard deviation of xᵢ and yᵢ over all M samples, respectively.

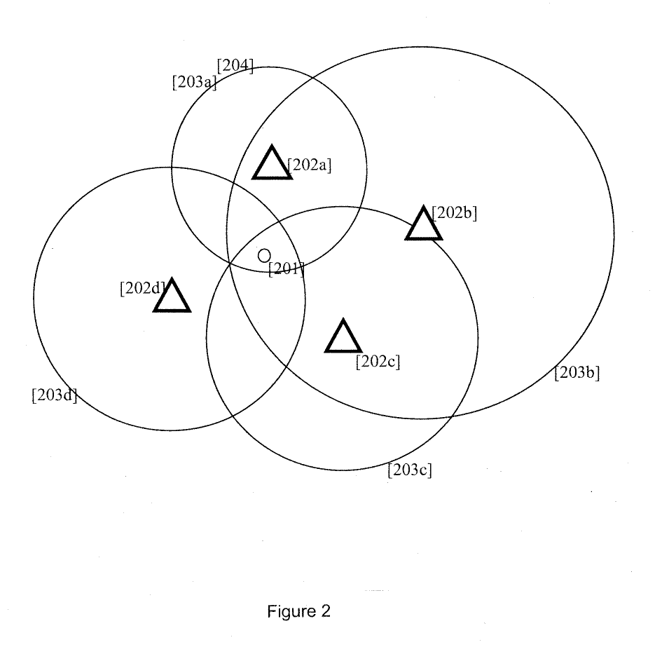

FIG. 2 illustrates an example of a WLAN-enabled mobile device and WLAN access points in its surroundings. In FIG. 2, the user [201] detects WLAN access points [202a-d] in range and estimates its location by using the detected WLAN access points as reference points. The access points [202a-d] in range have different coverage sizes [203a-d]. The estimation error is bounded by the minimum coverage [204] of the detected access points [202a-d]. For example, if the radius of the coverage area [203a] of the access point [202a] is 100 meters, the maximum estimation error corresponding to the position of user [201] is 100 meters.

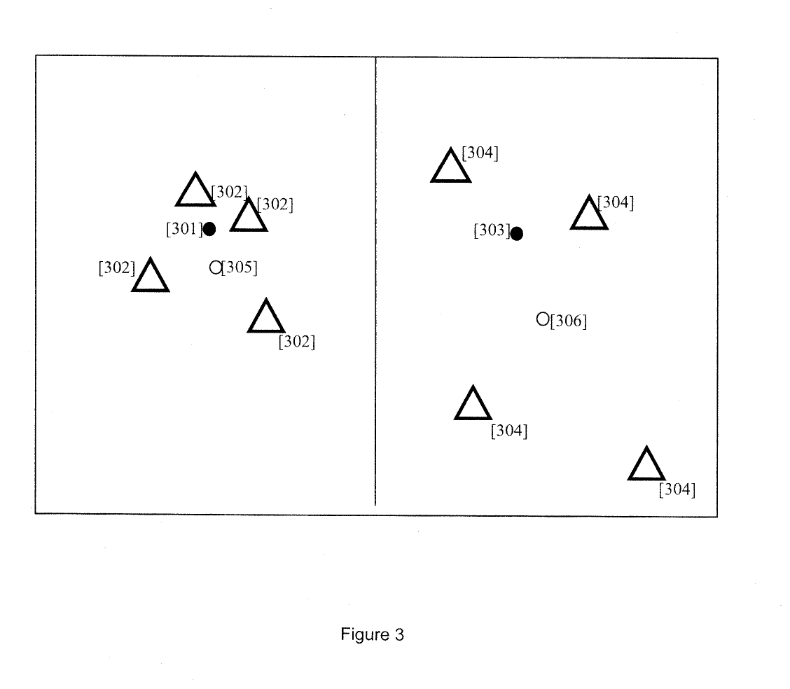

Under other embodiments of the invention, the expected error of a position estimation is estimated based on how the detected access points are spatially spread, i.e., the distance between the geographic location of the detected access points. An example of the impact of the spatial spread of the detected access points on the position estimation error is illustrated in FIG. 3. FIG. 3 illustrates a WLAN-enabled mobile device [301] with detected access points [302] and WLAN-enabled mobile device [303] with detected access points [304]. The estimated location of mobile devices [301] and [303] are shown by circles [305] and [306] respectively. The figure illustrates a smaller estimation error for mobile device [301] with a relatively smaller spatial spread of detected access points than mobile device [303], which has a relatively larger spatial spread of detected access points. The spatial spread of access points can be measured by the standard deviation of their location in the X and Y axis, σₛₓ and σ_{sy}, and then finding the total spatial spread standard deviation as follows:

σₛ=\sqrt{σₛₓ²+σ_{sy}²}

The expected error directly correlates with the standard deviation of spatial spread. So,

e∝f(σₛ).

An example of the above function is as follows:

e=Kₛσₛ

The parameter Kₛ is a constant number to scale the output value to error in meters. The parameter Kₛ translates the square of the standard deviation in m² to error in meters. The parameter K_{c} is found empirically by considering enough samples in the entire coverage area and finding the actual error and the standard deviation square value. Error in meters is calculated by using the technique described above.

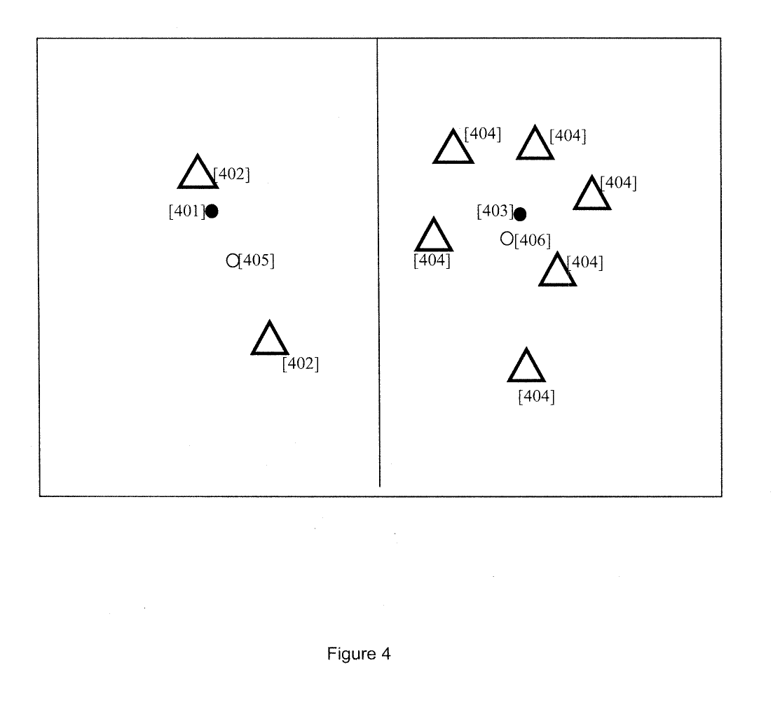

Under other embodiments of the invention, the expected error of a WLAN-enabled mobile device in a WLAN positioning system is estimated based on the number of access points that are detected. As illustrated in FIG. 4, the expected error decreases as the number of detected access points increases. FIG. 4 shows two WLAN-enabled mobile devices [401] and [403], with detected access points [402] and [404], respectively, and estimated positions [405] and [406], respectively. The figure illustrates that the expected error of position estimation is lower for WLAN-enabled mobile device [403] because of the greater number of access points used to estimate it position. Therefore, the expected error is correlated with the inverse of the number of detected access points. If N denotes the number of detected access points that are used to locate an end user, the expected error can be written as follows:

$$e ∝ f ( \frac{1}{N} )$$

An example of the above function is as follows:

$$e = {K}_{N} \frac{1}{\sqrt{N}}$$

The parameter K_{N} is a constant number to scale the output of the equation to error in meters. In terms of units, the parameter K_{N} is in meters. The parameter K_{N} is found empirically by considering enough samples in the entire coverage area and finding the actual error and the N value. Error in meters is calculated by using the technique described above.

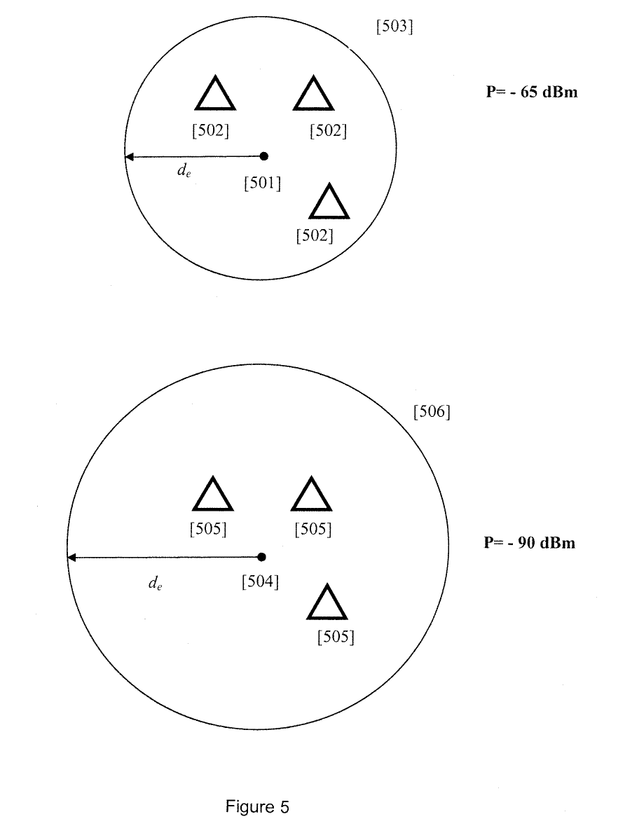

Under other embodiments of the invention, the expected error of a WLAN-enabled mobile device in a WLAN positioning system is estimated based on the maximal signal strength received from the access points which are used to locate an end user. The expected error decreases as the maximal signal strength received from the access points increases. Therefore, the expected error is correlated with the negative signal strength received from the access points used to locate an end user. An example of the impact of the maximal signal strength of the detected access points on the position estimation error is illustrated in FIG. 5. FIG. 5 illustrates a WLAN-enabled mobile device [501] with detected access points [502] and WLAN-enabled mobile device [504] with detected access points [505]. The maximal signal strength received by mobile device [501] is −65 dBm, and the maximal signal strength received by mobile device [504] is −90 dBm. The estimated location and estimated error of the location of mobile devices [501] and [504] are shown by circles [503] and [506] respectively. The figure illustrates a relatively smaller estimation error for mobile device [501], which has a relatively larger maximal signal strength of detected access points as compared with mobile device [504], which has a relatively smaller maximal signal strength of detected access points. If P denotes the maximal signal strength received from the access points that are used to locate an end user, the expected error can be written as follows:

e∝f(−P)

An example of the above function is as follows:

e=K_{P}*(−P)

The parameter K_{P} is a constant number, which translates the received signal strength power units to error in meters. The parameter K_{P} is found empirically by considering enough samples in the entire coverage area and finding the actual error and the standard deviation square value. Error in meters is calculated by using the technique described above.

Under other embodiments of the invention, the expected error of a WLAN-enabled mobile device in a WLAN positioning system is estimated based on combining multiple correlated parameters with error. The four parameters correlated with the expected error of a position estimate are as follows: (1) the smallest coverage of detected access points, Cₘᵢₙ, (2) one over square root of number of detected access points, 1/\sqrt{N}, (3) square of spatial spread of detected access points, σₛ², (4) maximal received signal strength (RSS) from the access points that are used to locate an end user, P.

The above parameters are correlated with the expected error, but in terms of their absolute values, those parameters have different dynamic ranges. To combine the parameters, the absolute values of the parameters are first standardized. In other words, the random variables can be viewed as random variables, which are standardized. Standardization of the parameters is achieved by first subtracting the average value of these parameters and dividing them by the standard deviation of the corresponding parameter. Average values and standard deviations of the parameters are found empirically from a large enough sample of end user location requests. Standardized values of the parameters can be seen as a distance from the average value of the parameter to the observed value of the parameter measured in terms of a standard deviation value.

The standardized parameters can be averaged or they can be weighted according to the accuracy with which each parameter predicts the expected error and then averaged, called weighted average herein. Weighting each component of error according to its accuracy of error prediction is more desirable, and it is the optimum combining method. The next step in the weighted average approach is defining a metric for each of the parameters that measures the accuracy of the error prediction.

The correlation of each parameter with the error measures the accuracy of the error prediction of the particular error estimation method. These correlation coefficients are used to weight each method in the weighted average calculation. A correlation coefficient is a statistical parameter, which is determined globally for each parameter based on a sufficient number of samples for the targeted geographic area by finding the actual error of a position estimate and also finding the estimated value of the parameter and then determining the correlation coefficient. Therefore, the correlation coefficient shows the statistical correlation of an estimation parameter with estimation error, and it does not show exactly the quality of one sample of the parameter. For example, one instance of a position determination might have a very small estimation error, but the smallest coverage area of the detected access points might be relatively large. In this example, the smallest coverage area of the detected access points is not a good indicator of the error, but it is still weighted with the same correlation coefficient as other samples. Therefore, the expected error using weighted average of the error parameters is written as follows:

$$e ∝ [ \begin{matrix}{C}_{c} \frac{{C}_{min} - E ( {C}_{min} )}{σ ( {C}_{min} )} + {C}_{N} \frac{\sqrt{1 / N} - E ( \sqrt{1 / N} )}{σ ( \sqrt{1 / N} )} + \\ + {C}_{s} \frac{{σ}_{s}^{2} - E ( {σ}_{s}^{2} )}{σ ( {σ}_{s}^{2} )} + {C}_{P} \frac{- P - E ( - P )}{σ ( - P )}\end{matrix} ] \times \frac{1}{( {C}_{c} + {C}_{N} + {C}_{s} + {C}_{P} )} \qquad Eq . ( 1 )$$

In the above equation, the average values of the parameters are shown as expected values with the notation E. The standard deviation operator is shown as σ and the correlation coefficients for Cₘᵢₙ, N, σₛ, and P are shown with C_{c}, C_{N}, Cₛ and C_{P}, respectively. The correlation coefficients are unitless. The correlation coefficients are found empirically by considering enough samples in the entire coverage area and comparing the expected error with the actual error for each sample. In the above formula the values of e can be seen as a distance from the average expected error value to the expected error value measured in standard deviations.

Under other embodiments of the invention, the expected error of a position estimate is found in meters from a parameter that is correlated with the expected error. Assuming that there is a parameter correlated with the expected error, the estimation error in meters is found by mapping the distribution of the error parameter into the actual distance error in meters as found during scanning the targeted geographic area. Therefore, if expected error in meters is denoted by dₑ, it is found as the result of the mapping and can be calculated as follows:

dₑ=e*σ(dₑ)+ d̅ₑ Eq. (2)

Note that the average value of a random process is shown with a bar over the variable and the standard deviation operator is shown with σ. The average and the standard deviation of dₑ and e are found empirically by considering the distribution of these parameters over samples that are collected from the entire coverage area. An illustrative example of the standard deviation and the average value of the parameters are as follows:

E(Cₘᵢₙ)=40

σ(Cₘᵢₙ)=20

E(\sqrt{1/N})=0.33

σ(\sqrt{1/N})=0.12

E(σₛ²)=50

σ(σₛ²)=100

E(−P)=75 dBm

σ(−P)=10 dBm

d̅ₑ=67.2 m

σ_{d}_{ₑ}=40.8 m

Note that the standard deviation of spatial spread of detected access points is determined based on the latitude and longitude of access points.

An illustrative example of the correlation coefficients for Cₘᵢₙ, N, σₛ, and −P follows below.

C_{c}=0.59

C_{N}=0.2

Cₛ=0.17

C_{P}=0.15

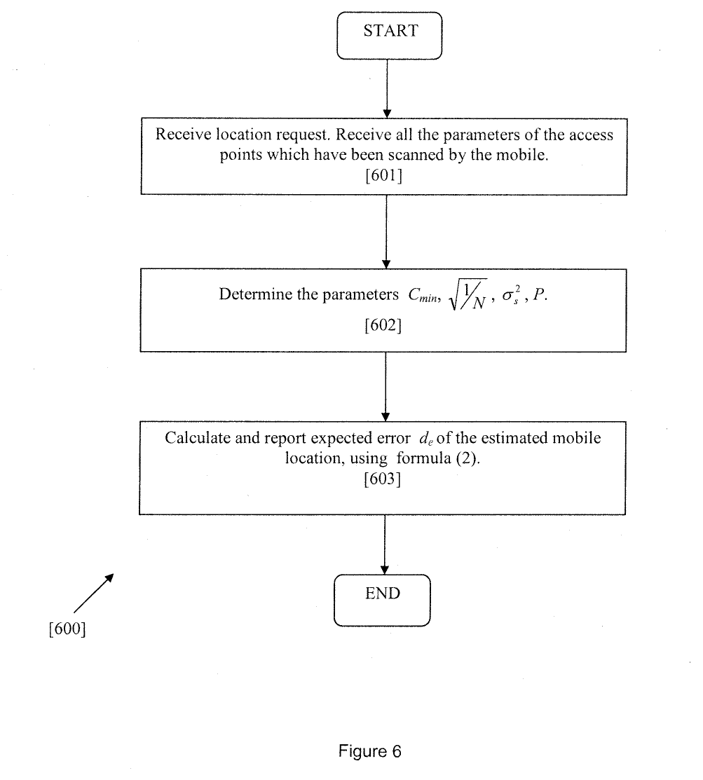

FIG. 6 illustrates a flow chart of a process [600] for determining an estimate of expected error of a position estimate of a mobile device. First, a location request is received and all parameters of access points scanned by a mobile device are received (step [601]). Next, the values of the parameters Cₘᵢₙ, \sqrt{1/N}, σₛ², P are determined (step [602]) as set forth above. Finally, the expected error of a position estimate of the mobile device is determined using Eqs. (1) and (2) above (step [603]).

Under other embodiments of the invention, the accuracy of the expected error of a position estimate is improved. As set forth above, Eq. (2) relies on Eq. (1), and Eq. (1) relies on correlation coefficients C_{c}, C_{N}, Cₛ and C_{P} as well as average values and standard deviations of appropriate functions of four parameters: Cₘᵢₙ, N, σₛ, and P. The values of these parameters can vary significantly for different regions of parameter N, which denotes the number of detected access points used to locate a mobile device. Different regions of N can be set forth as follows:

0<N≦N₁, N₁<N≦N₂, N₂<N≦N₃, . . . , Nₖ₋₁<N≦Nₖ, . . . , Nₘₐₓ₋₁<N≦Nₘₐₓ,

where N₁, N₂, . . . , Nₖ, . . . , Nₘₐₓ are constants.

In such an implementation, all values of correlation coefficients C_{c}, C_{N}, Cₛ and C_{P}, average values, and standard deviations of appropriate functions of four parameters: Cₘᵢₙ, N, σₛ, and P are found separately for all different cases: 0<N≦N₁, N₁<N≧N₂, N₂<N≧N₃, . . . , Nₖ₋₁<N≦Nₖ, . . . , Nₘₐₓ₋₁<N≦Nₘₐₓ. After this, the expected error result, i.e., Eq. (2), is found separately, corresponding to all different cases: 0<N≧N₁, N₁<N≧N₂, N₂<N≧N₃, . . . , Nₖ₋₁<N≧Nₖ, . . . , Nₘₐₓ₋₁<N≧Nₘₐₓ.

The following example is provided to illustrate the approach set forth above. In this example, N₀=3. It has been observed that the values of the correlation coefficients, average values, and standard deviations can vary considerably between the usage case when N<N₀ and the usage case when N≧N₀, where N₀ is a relatively small value. Namely, in usages cases where N<N₀, the values of the above parameters are substantially more “noisy” than in the usage case where N≧N₀. In other words, in the usage case N<N₀, the distribution of the parameters and correlation coefficients becoming less predictable and less reliable than in the case of N≧N₀. Therefore, two different equations of the form of Eq. (2) are introduced for the two different cases: N<N₀ and N≧N₀.

In each case, the values of the correlation coefficients, average values, and, standard deviations of the parameters corresponding to the appropriate usage case (i.e., N<N₀ or N≧N₀) are used in determining expected error of a position estimate. The values of correlation coefficients, average values, and standard deviations of the parameters corresponding to the appropriate case are found empirically by considering a large enough set of samples belonging to each usage case. This method allows the accuracy of Eq. (2) to be improved substantially.

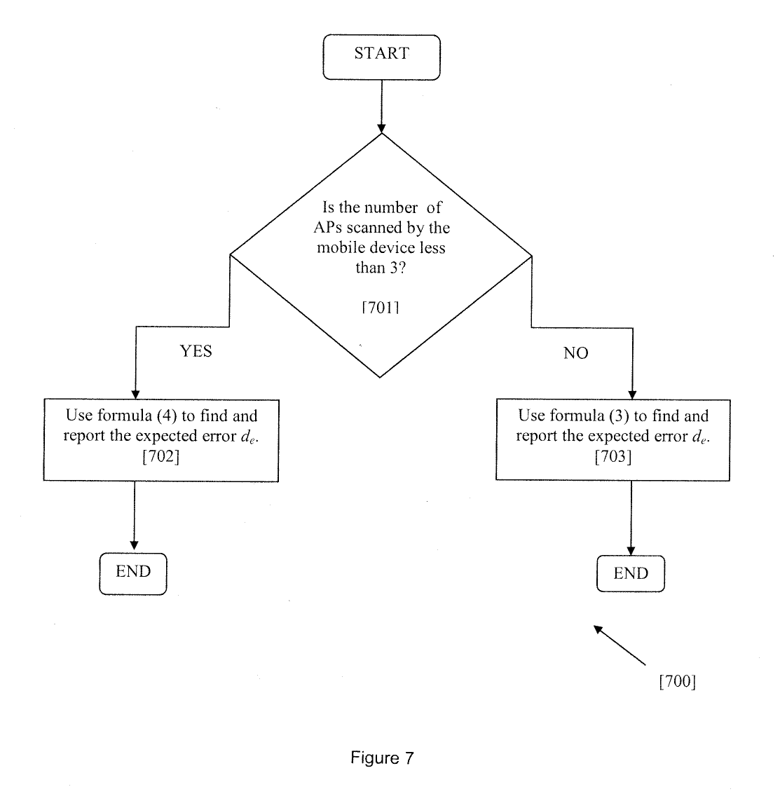

FIG. 7 illustrates a flow chart of a process [700] for determining an expected error of a position estimate of a mobile device in two different usage cases. After scanning for and detecting surrounding access points, the number of detected access points is determined and compared to the value of N₀ (step [701]). If the usage case is N≧3, then the following Equation (3) is used to determine the expected error of the position estimate (step [703]).

$${d}_{e} = 42.4 * [ \begin{matrix}0.59 * \frac{{C}_{min} - 3.9}{2} + 0.2 * \frac{\sqrt{1 / N} - .32}{0.12} + \\ + 0.17 * \frac{{σ}_{s}^{2} - 2 * {10}^{- 7}}{5 * {10}^{- 7}} + 0.15 * \frac{- P - 75}{10}\end{matrix} ] * \frac{1}{1.11} + 68 \qquad Eq . ( 3 )$$

If the usage case is N<3, then the following Equation (4) is used to determine the expected error of the position estimate (step [702]).

$${d}_{e} = 150 * [ \begin{matrix}0.35 * \frac{{C}_{min} - 6.5}{2.69} + 0.15 * \frac{\sqrt{1 / N} - .82}{0.145} + \\ + ( N - 1 ) * 0.4 * \frac{{σ}_{s}^{2} - 1.3 * {10}^{- 6}}{3.7 * {10}^{- 6}} + 0.15 * \frac{- P - 80}{8.17}\end{matrix} ] * \frac{1}{( 0.65 + 0.4 * ( N - 1 ) )} + 230 \qquad Eq . ( 4 )$$

It is understood that the above example is merely illustrative of one implementation, and that N₀ can be greater or lesser than 3. Also, additional usage cases are envisioned, each having a corresponding equations to determine the expected error of a position estimate.

The techniques and systems disclosed herein may be implemented as a computer program product for use with a computer system or computerized electronic device. Such implementations may include a series of computer instructions, or logic, fixed either on a tangible medium, such as a computer readable medium (e.g., a diskette, CD-ROM, ROM, flash memory or other memory or fixed disk) or transmittable to a computer system or a device, via a modem or other interface device, such as a communications adapter connected to a network over a medium.

The medium may be either a tangible medium (e.g., optical or analog communications lines) or a medium implemented with wireless techniques (e.g., WiFi, cellular, microwave, infrared or other transmission techniques). The series of computer instructions embodies at least part of the functionality described herein with respect to the system. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Moreover, the techniques and systems disclosed herein can be used with a variety of mobile devices. For example, mobile telephones, smart phones, personal digital assistants, satellite positioning units (e.g., UPS devices), and/or mobile computing devices capable of receiving the signals discussed herein can be used in implementations of the invention. The location estimate and corresponding expected error of the position estimate can be displayed on the mobile device and/or transmitted to other devices and/or computer systems. Further, it will be appreciated that the scope of the present invention is not limited to the above described embodiments, but rather is defined by the appended claims; and that these claims will encompass modifications of and improvements to what has been described.

What is claimed is:

1. In a WLAN positioning system for estimating the position of a WLAN-enabled device, a method of estimating an expected error of a position estimate, a method comprising:
the WLAN-enabled device receiving signals transmitted by at least one WLAN access point in range of the WLAN-enabled device;
estimating the position of the WLAN-enabled device based on the received signals from the at least one WLAN access point in range of the WLAN enabled device;
measuring a signal strength value for the signals transmitted by the at least one WLAN access point;
determining a maximum signal strength value for the measured signal strength values; and
estimating an expected error of the position estimate based on the maximum signal strength value of the signals transmitted by the at least one WLAN access point in range of the WLAN enabled device, wherein the expected error predicts a relative accuracy of the position estimate.

2. The method of claim 1, wherein estimating the position of the WLAN-enabled device is based on signals from a plurality of WLAN access point in range of the WLAN-enabled device and wherein estimating the expected error of the position estimate of the WLAN-enabled device is based on a weighted average of a first expected error value estimated based on the maximum signal strength value of the signals transmitted by the plurality of WLAN access points in range of the WLAN enabled device, a second expected error value estimated based on the number of WLAN access points of the plurality used to estimate the position of the WLAN enabled device, a third expected error value estimated based on a smallest signal coverage area of the plurality of WLAN access points used to estimate the position of the WLAN-enabled device, and a fourth expected error value estimated based on a spatial spread of the geographic positions of the plurality of WLAN access points used to estimate the position of the WLAN-enabled device, the spatial spread being based on a distance between the geographic positions of the plurality of WLAN access points used to estimate the position of the WLAN-enabled device.

3. The method of claim 2, wherein the first, second, third, and fourth expected error values are weighted according to corresponding correlation coefficients, each correlation coefficient measuring the accuracy with which its corresponding expected error value predicts the actual error.

4. The method of claim 3, wherein the first, second, third, and fourth expected error values are standardized according to a dynamic range of the corresponding error value.

5. The method of claim 2, further comprising, based on the number of WLAN access points in range of the WLAN-enabled device for which signals are received, choosing a corresponding weighted average algorithm for estimating the expected error of the position estimate from a plurality of weighted average algorithms, said chosen weighted average algorithm being suited for the number of WLAN access points in range of the WLAN-enabled device for which signals are received.

6. The method of claim 5, wherein a first weighted average algorithm is chosen when the number of WLAN access points in range of the WLAN-enabled device for which signals are received is less than three and a second weighted average algorithm is chosen when the number of WLAN access points in range of the WLAN-enabled device for which signals are received is three or more.

7. The method of claim 1, wherein the WLAN-enabled device estimates the expected error of the position estimate.

8. The method of claim 1, wherein a server system estimates the expected error of the position estimate.

9. In a WLAN positioning system for estimating the position of a WLAN-enabled device, a system for estimating an expected error of a position estimate, the system for estimating the expected error comprising:
a WLAN-enabled device for receiving signals transmitted by at least one WLAN access point in range of the WLAN-enabled device;
a computer readable medium comprising instructions that, when executed, cause a computer system to:
estimate the position of the WLAN-enabled device based on the received signals from the at least one WLAN access point in range of the WLAN enabled device;
measure a signal strength value for the signals transmitted by the at least one WLAN access point;
determine a maximum signal strength value for the measured signal strength values; and
estimate an expected error of the position estimate based on the maximum signal strength value of the signals transmitted by the at least one WLAN access point in range of the WLAN enabled device, wherein the expected error predicts a relative accuracy of the position estimate.

10. The system of claim 9, wherein estimating the position of the WLAN-enabled device is based on signals from a plurality of WLAN access point in range of the WLAN-enabled device and wherein estimating the expected error of the position estimate of the WLAN-enabled device is based on a weighted average of a first expected error value estimated based on the maximum signal strength value of the signals transmitted by the plurality of WLAN access points in range of the WLAN enabled device, a second expected error value estimated based on the number of WLAN access points of the plurality used to estimate the position of the WLAN enabled device, a third expected error value estimated based on a smallest signal coverage area of the plurality of WLAN access points used to estimate the position of the WLAN-enabled device, and a fourth expected error value estimated based on a spatial spread of the geographic positions of the plurality of WLAN access points used to estimate the position of the WLAN-enabled device, the spatial spread being based on a distance between the geographic positions of the plurality of WLAN access points used to estimate the position of the WLAN-enabled device.

11. The system of claim 10, wherein the first, second, third, and fourth expected error values are weighted according to corresponding correlation coefficients, each correlation coefficient measuring the accuracy with which its corresponding expected error value predicts the actual error.

12. The system of claim 11, wherein the first, second, third, and fourth expected error values are standardized according to a dynamic range of the corresponding error value.

13. The system of claim 10, the computer readable medium further comprising instructions that, when executed, cause the computer system to, based on the number of WLAN access points in range of the WLAN-enabled device for which signals are received, choose a corresponding weighted average algorithm for estimating the expected error of the position estimate from a plurality of weighted average algorithms, said chosen weighted average algorithm being suited for the number of WLAN access points in range of the WLAN-enabled device for which signals are received.

14. The system of claim 13, wherein the instructions cause the computer system to choose a first weighted average algorithm when the number of WLAN access points in range of the WLAN-enabled device for which signals are received is less than three and to choose a second weighted average algorithm when the number of WLAN access points in range of the WLAN-enabled device for which signals are received is three or more.

15. The system of claim 9, wherein the instructions are executed on the WLAN-enabled device.

16. The system of claim 9, wherein the instructions are executed on a server system.
